(19) United States
(12) Patent Application Publication
(10) Pub. No.: US 2025/0119782 A1
(43) Pub. Date: Apr. 10, 2025

(54) PROCESSING METHOD FOR SENSING MEASUREMENT, AND DEVICE

(71) Applicant: VIVO MOBILE COMMUNICATION CO., LTD., Dongguan (CN)

(72) Inventors: Jian YAO, Dongguan (CN); Dajie JIANG, Dongguan (CN); Shengli DING, Dongguan (CN)

(73) Assignee: VIVO MOBILE COMMUNICATION CO., LTD., Dongguan (CN)

(21) Appl. No.: 18/942,510

(22) Filed: Nov. 9, 2024

Related U.S. Application Data
(63) Continuation of application No. PCT/CN2023/092489, filed on May 6, 2023.

(30) Foreign Application Priority Data
May 10, 2022 (CN) 202210505485.4

(51) Int. Cl. H04W 24/10; H04W 12/03; H04W 64/00

(52) U.S. Cl. CPC H04W 24/10; H04W 12/03; H04W 64/006

(57) ABSTRACT

This application discloses a processing method for sensing measurement, and a device. The processing method for sensing measurement in this application includes: a first device receiving a first sensing measurement result, and the first device obtains a target sensing measurement result based on the first sensing measurement result and the target sensing signal. The first sensing measurement result is sent by a third device based on a target sensing signal. The target sensing signal is generated by a second device based on a sensing measurement encryption requirement. The target sensing signal is used for a target sensing task.

### CROSS-REFERENCE TO RELATED APPLICATIONS

This application is a continuation of International Application No. PCT/CN 2023/092489, filed on May 6, 2023, which claims priority to Chinese Patent Application No. 202210505485.4, filed on May 10, 2022. The entire contents of each of the above-referenced applications are expressly incorporated herein by reference.

### TECHNICAL FIELD

This application relates to the field of communication technologies, and specifically, to a processing method for sensing measurement, and a device.

### BACKGROUND

In addition to a communication capability, a mobile communication system is to further have a sensing capability. The sensing capability is the ability of one or more devices to sense information such as an orientation, a range, or a velocity of a target object or to detect, track, recognize, or image a target object, an event, an environment, or the like by sending and receiving a wireless signal. Some results obtained through wireless sensing are private and may pose security risks or information leakage risks.

### SUMMARY

Embodiments of this application provide a processing method for sensing measurement, a terminal, and a network side device.

According to a first aspect, a processing method for sensing measurement is provided, including: A first device receives a first sensing measurement result. The first sensing measurement result is sent by a third device based on a target sensing signal. The target sensing signal is generated by a second device based on a sensing measurement encryption requirement. The target sensing signal is used for a target sensing task. The first device obtains a target sensing measurement result based on the first sensing measurement result and the target sensing signal.

According to a second aspect, a processing method for sensing measurement is provided, including: A second device generates a target sensing signal based on a sensing measurement encryption requirement. The second device sends the target sensing signal. The target sensing signal is used for a target sensing task.

According to a third aspect, a processing method for sensing measurement is provided, including: A third device receives a target sensing signal. The target sensing signal is generated by a second device based on a sensing measurement encryption requirement. The target sensing signal is used for a target sensing task.

According to a fourth aspect, a second device is provided, including: a processing module, configured to generate a target sensing signal based on a sensing measurement encryption requirement; and a communication module, configured to send the target sensing signal. The target sensing signal is used for a target sensing task.

According to a fifth aspect, a third device is provided, including: a communication module, configured to receive a target sensing signal. The target sensing signal is generated by a second device based on a sensing measurement encryption requirement. The target sensing signal is used for a target sensing task.

According to a sixth aspect, a first device is provided, including: a communication module, configured to receive a first sensing measurement result, where the first sensing measurement result is sent by a third device based on a target sensing signal, the target sensing signal is generated by a second device based on a sensing measurement encryption requirement, and the target sensing signal is used for a target sensing task; and a processing module, configured to obtain a target sensing measurement result based on the first sensing measurement result and the target sensing signal.

According to a seventh aspect, a terminal is provided. The terminal includes a processor and a memory. The memory stores a program or instructions executable in the processor. The program or the instructions, when executed by the processor, implement the steps of the method described in any one of the first aspect to the third aspect.

According to an eighth aspect, a terminal is provided, including a processor and a communication interface. The processor and the communication interface are configured to implement the steps of the method described in any one of the first aspect to the third aspect.

According to a ninth aspect, a network side device is provided. The network side device includes a processor and a memory. The memory stores a program or instructions executable in the processor. The program or the instructions, when executed by the processor, implement the steps of the method described in any one of the first aspect to the third aspect.

According to a tenth aspect, a network side device is provided, including a processor and a communication interface. The processor and the communication interface are configured to implement the steps of the method described in any one of the first aspect to the third aspect.

According to an eleventh aspect, an encryption processing system for sensing measurement is provided, including a terminal and a network side device. The terminal may be configured to perform the steps of the method described in any one of the first aspect to the third aspect. The network side device may be configured to perform the steps of the method described in any one of the first aspect to the third aspect.

According to a twelfth aspect, a readable storage medium is provided. The readable storage medium stores a program or instructions. The program or the instructions, when executed by a processor, implement the steps of the method described in any one of the first aspect to the third aspect.

According to a thirteenth aspect, a chip is provided. The chip includes a processor and a communication interface. The communication interface is coupled to the processor. The processor is configured to execute a program or instructions, to implement the steps of the method described in any one of the first aspect to the third aspect.

According to a fourteenth aspect, a computer program/program product is provided. The computer program/program product is stored in a storage medium. The computer program/program product is executed by at least one processor, to implement the steps of the method described in any one of the first aspect to the third aspect.

In embodiments of this application, the second device generates the target sensing signal based on the sensing measurement encryption requirement, and sends the target sensing signal. Since the sent target sensing signal is generated based on the sensing measurement encryption requirement, a specific device can obtain a correct sensing measurement result, which helps improve security of the sensing result.

### BRIEF DESCRIPTION OF THE DRAWINGS

FIG. 1 is a schematic diagram of a wireless communication system according to an embodiment of this application;

FIG. 2 is a schematic flowchart of a processing method for sensing measurement according to an embodiment of this application;

FIG. 3 is a schematic diagram of a first sensing signal according to an embodiment of this application;

FIG. 4 is a schematic flowchart of a processing method for sensing measurement according to an embodiment of this application;

FIG. 5 is a schematic flowchart of a processing method for sensing measurement according to an embodiment of this application;

FIG. 6 is a schematic structural diagram of a second device according to an embodiment of this application;

FIG. 7 is a schematic structural diagram of a third device according to an embodiment of this application;

FIG. 8 is a schematic structural diagram of a first device according to an embodiment of this application;

FIG. 9 is a schematic structural diagram of a communication device according to an embodiment of this application;

FIG. 10 is a schematic structural diagram of a terminal according to an embodiment of this application;

FIG. 11 is a schematic structural diagram of a network side device according to an embodiment of this application; and

FIG. 12 is a schematic structural diagram of a network side device according to an embodiment of this application.

### DETAILED DESCRIPTION

Technical solutions in embodiments of this application are clearly described below with reference to accompanying drawings in embodiments of this application. Apparently, the described embodiments are merely some rather than all embodiments of this application. All other embodiments obtained by a person of ordinary skill in the art based on embodiments of this application fall within the protection scope of this application.

Terms “first”, “second”, and the like in the specification and the claims of this application are used to distinguish between similar objects, and are not used to describe a specific order or sequence. It should be understood that the terms used in this way may be transposed where appropriate, so that embodiments of this application may be implemented in a sequence other than those illustrated or described herein. In addition, objects defined by “first” and “second” are generally of the same class and do not limit a quantity of objects. For example, one or more first objects may be arranged. In addition, “and/or” in the specification and the claims indicates at least one of connected objects, and a character “/” generally indicates an “or” relationship between associated objects.

It should be noted that, technologies described in embodiments of this application may be applied to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” in embodiments of this application are usually interchangeably used, and the described technology may be used for both the system and the radio technology mentioned above, or may be used for another system and another radio technology. A new radio (New Radio, NR) system is described below for an illustrative purpose, and the term NR is used in most of the following descriptions, but the technologies may also be applied to applications other than applications of the NR system, such as a 6^{th} Generation (6G) communication system.

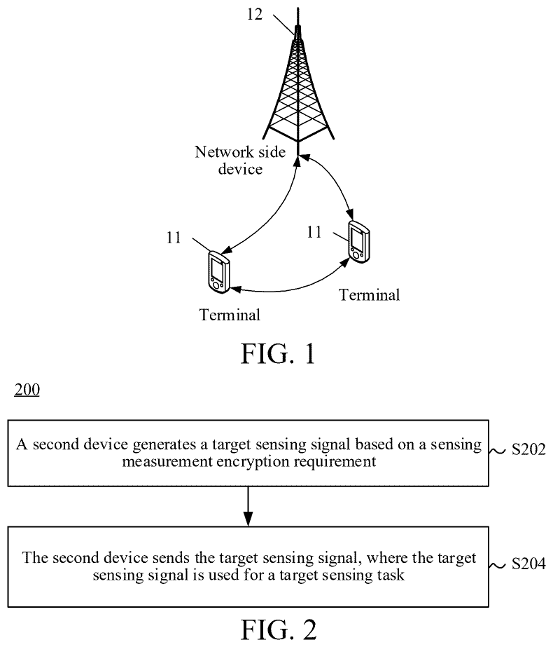

FIG. 1 is a block diagram of a wireless communication system to which embodiments of this application may be applied. The wireless communication system includes a terminal 11 and a network side device 12. The terminal 11 may be a terminal side device such as a mobile phone, a tablet computer, a laptop computer, which is also referred to as a notebook computer, a Personal Digital Assistant (PDA), a palm computer, a netbook, an Ultra-Mobile Personal Computer (UMPC), a Mobile Internet Device (MID), an Augmented Reality (AR)/Virtual Reality (VR) device, a robot, a wearable device, an on-board device, a Vehicle User Equipment (VUE), a Pedestrian User Equipment (PUE), smart home (a home device with a wireless communication capability, such as a refrigerator, a television, a washing machine, or furniture), a game console, a Personal Computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. It should be noted that, a specific type of the terminal 11 is not limited in embodiments of this application. The network side device 12 may include an access network device or a core network device. The access network device may also be referred to as a wireless access network device, a Radio Access Network (RAN), a wireless access network function, or a wireless access network unit. The access network device may include a base station, a Wireless Local Area Network (WLAN) access point, a Wireless Fidelity (Wi-Fi) node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a household NodeB, a household evolved NodeB, a Transmission Reception Point (TRP), or some other appropriate term in the field, as long as the same technical effect is achieved. The base station is not limited to a specific technical term. It should be noted that, in embodiments of this application, only a base station in the NR system is used as an example, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in embodiments of this application, only a core network device in the NR system is used as an example, but the specific type of the core network device is not limited.

A processing method for sensing measurement provided in embodiments of this application is described below in detail through some embodiments and application scenarios with reference to the accompanying drawings.

This application mainly involves four devices, namely a first device, a second device, a third device, and a fourth device.

First device: It is a sensing network function or a sensing element (Sensing MF), which may be located on a Radio Access Network (RAN) side or a core network side, refers to a network node in the core network and/or the RAN that is responsible for at least one function such as sensing request processing, sensing resource scheduling, sensing information interaction, and sensing data processing, may be an upgrade based on an AMF or a Location Management Function (LMF) in the 5^{th} Generation Mobile Communication Technology (5G) network, or may be another network node or a newly defined network node.

Second device: It is a sending device for a sensing signal, which may be a base station or a terminal (for example, a User Equipment (UE)). If the second device is a UE, signaling interaction between the second device and the first device may be performed through an access base station of the second device, and signaling interaction between the second device and a third device may be performed through the access base station of the second device or through a sidelink (in a case that the third device is also a UE). If the second device is a base station, and the third device is also a base station, the signaling interaction between the second device and the third device is performed through an Xn interface. For brevity of description, the foregoing process is not described in detail in the following description.

Third device: It is a receiving device for a sensing signal, which may be a base station or a UE. If the third device is a UE, signaling interaction between the third device and the first device may be performed through an access base station of the third device, and signaling interaction between the third device and the second device may be performed through the access base station of the third device or through a sidelink (in a case that the second device is also a UE). If the third device is a base station and the second device is also a base station, the signaling interaction between the third device and the second device is performed through an Xn interface. For brevity of description, the foregoing process is not described in detail in the following description.

Fourth device: It is a computing device for a sensing measurement result, which may be a base station, a UE, or a core network node that does not participate in sending or receiving of a sensing signal, and is responsible for obtaining a first sensing measurement result and calculating a target sensing measurement result.

A main process of embodiments of this application is substantially as follows.

A first device sends first information to a second device, which is used to indicate a sensing measurement encryption requirement. The second device generates a target sensing signal based on the sensing measurement encryption requirement, and sends the target sensing signal to a third device. The third device detects the target sensing signal, and obtains a first sensing measurement result.

The third device may send the first sensing measurement result to the second device. The second device obtains a target sensing measurement result reflecting real channel information based on the first sensing measurement result and the target sensing signal, and then sends the target sensing measurement result to the first device. Alternatively, the third device may further directly send the first sensing measurement result to the first device. The first device obtains the target sensing measurement result reflecting the real channel information based on the first sensing measurement result and the target sensing signal, and further obtains a sensing result. Alternatively, the third device sends the first sensing measurement result to a fourth device. The fourth device obtains the target sensing measurement result reflecting the real channel information based on the first sensing measurement result and the target sensing signal, and sends the target sensing measurement result to the first device.

The first device may further send second information to the third device. The second information includes at least a manner of generating a third sensing signal. For example, the third device detects the target sensing signal based on the third sensing signal to obtain second channel information H″. The third device may obtain a second sensing measurement result based on H″, and send the second sensing measurement result to the second device. The second device obtains a third sensing measurement result based on the target sensing signal and the second sensing measurement result, and sends the third sensing measurement result to the first device. The first device obtains the target sensing measurement result reflecting the real channel information based on the third sensing measurement result and the third sensing signal, and further obtains the sensing result. Alternatively, the third device may further obtain the second sensing measurement result based on H″, and send the second sensing measurement result to the first device. The first device obtains the target sensing measurement result reflecting the real channel information based on the second sensing measurement result, the target sensing signal, and the third sensing signal, and further obtains the sensing result.

It should be noted that, the foregoing process is not a specific limitation on embodiments of this application. The foregoing process may be further expanded or partially modified in embodiments described below.

As shown in FIG. 2, an embodiment of this application provides a processing method 200 for sensing measurement. The method may be performed by a second device. In other words, the method may be performed by software or hardware installed in the second device. The method includes the following steps.

S202: A second device generates a target sensing signal based on a sensing measurement encryption requirement.

For example, before S202, the method further includes: The second device receives first information from a first device, where the first information is used to indicate the sensing measurement encryption requirement. In this way, in S202, the second device generates the target sensing signal based on the indication of the first information.

For example, the first information includes at least one of the following:
1) a manner of generating the target sensing signal, where the manner of generating the target sensing signal may include the sensing measurement encryption requirement, and the like;
2) an encryption requirement identifier, where the encryption requirement identifier is used to indicate whether to perform encryption on a first sensing signal;
3) a sensing measurement result that needs to be encrypted, where the sensing measurement result includes, for example, a range/delay and a velocity/Doppler;
4) information of a sensing measurement node which is prohibited from obtaining or allowed to obtain a valid sensing measurement result, for example, an identity identifier of a target base station or a UE;
5) time information of the sensing measurement node which is prohibited from obtaining or allowed to obtain the valid sensing measurement result, which may be for example an entire sensing measurement period; and
6) information of a position at which obtaining of the valid sensing information is prohibited or allowed, where the information of the position includes, for example, an area and a direction.

The sensing measurement encryption requirement described above is indicated by the first device through the first information. In another embodiment, the sensing measurement encryption requirement may be further predefined, for example, as agreed by a protocol.

S204: The second device sends the target sensing signal, where the target sensing signal is used for a target sensing task.

In this embodiment, the target sensing signal is used for the target sensing task, for example, used to obtain information such as an orientation, a range, and a velocity of a target object, or used to detect, track, recognize, and image a target object, an event, an environment, or the like.

For example, before the second device sends the target sensing signal, the method further includes: The second device sends indication information to a third device. The indication information is used to indicate that the target sensing signal is a sensing signal generated based on the sensing measurement encryption requirement. The third device is configured to receive the target sensing signal. This embodiment is beneficial for the third device to receive the target sensing signal in an appropriate receiving manner, thereby improving communication efficiency.

Regarding how the third device processes the target sensing signal after the second device sends the target sensing signal, reference may be made to descriptions of subsequent embodiments.

According to the processing method for sensing measurement provided in embodiments of this application, the second device generates the target sensing signal based on the sensing measurement encryption requirement, and sends the target sensing signal. Since the sent target sensing signal is generated based on the sensing measurement encryption requirement, a specific device can obtain a correct sensing measurement result, which helps improve security of the sensing result.

In this embodiment of this application, the signal is encrypted during the sending of the sensing signal, which can meet a sensing privacy requirement without affecting sensing performance, to prevent leakage of a valid sensing measurement result.

For example, the sensing measurement encryption requirement mentioned in embodiments of this application includes at least one of the following:
1) A first encryption process is performed on a first sensing signal, to obtain the target sensing signal. In this way, in S202, the second device may generate the first sensing signal, and perform the first encryption process on the first sensing signal, to obtain the target sensing signal.

In the example, the first sensing signal may be a sensing signal known to the second device and the third device, that is, a sensing signal pre-agreed upon by a receiver and a sender.
2) A second sensing signal (which is unknown to the third device) is used as the target sensing signal. The third device is configured to receive the target sensing signal. The second device and the third device do not predefine the second sensing signal. In this way, in S202, the second device generates the second sensing signal unknown to the third device as the target sensing signal.

In the example, the second sensing signal may be a sensing signal unknown to the third device, that is, a sensing signal not pre-agreed upon by the receiver and the sender.

For example, in a case that the sensing measurement encryption requirement is to perform the first encryption process on the first sensing signal, the method further includes: The second device generates a first encrypted signal. The first encrypted signal is used to perform phase rotation on the first sensing signal. That the first encryption process is performed on the first sensing signal, to obtain the target sensing signal includes: performing phase rotation on the first sensing signal by using the first encrypted signal, to obtain the target sensing signal. In the example, the second device generates the first encrypted signal and multiplies the first encrypted signal by the first sensing signal, which is equivalent to performing the phase rotation on the first sensing signal. A manner of generating the first encrypted signal may be determined by the second device based on the first information.

For example, each time-domain position of the first sensing signal corresponds to one first encrypted signal, and each of the first encrypted signals includes m elements (for example, subcarriers).

In the example, each time-domain position of the first sensing signal corresponds to one first encrypted signal, and each first encrypted signal includes m elements (a quantity of elements included in each encrypted signal is the same as a quantity of elements included in each first sensing signal). The multiplying the first encrypted signal by the first sensing signal may be multiplying or conjugating the first sensing signal corresponding to each identical moment by the first encrypted signal in a frequency domain.

In an example, a plurality of time-domain positions correspond to a same first encrypted signal, and the m elements of each first encrypted signal are not exactly the same. In other words, the phase rotation is performed on the first sensing signal only in the frequency domain. In this case, range/delay information can be encrypted. For a specific manner, reference may be made to Embodiment I.

In another example, the first encrypted signals corresponding to the plurality of time-domain positions are not exactly the same, and the m elements of each first encrypted signal are the same. In other words, the phase rotation is performed on the first sensing signal only in a time domain. In this case, velocity/Doppler information can be encrypted. For a specific manner, reference may be made to Embodiment II.

In yet another example, the first encrypted signals corresponding to the plurality of time-domain positions are not exactly the same, and the m elements of each first encrypted signal are not exactly the same. In other words, the phase rotation is performed on the first sensing signal in the frequency domain and the time domain. In this case, the range/delay information and the velocity/Doppler information can be encrypted. For a specific manner, reference may be made to Embodiment III.

For example, based on the foregoing embodiments, after the second device sends the target sensing signal, the method further includes: The second device receives a first sensing measurement result. The first sensing measurement result is sent by a third device based on the target sensing signal. The second device obtains a target sensing measurement result based on the first sensing measurement result and the target sensing signal.

In this embodiment, that the third device may detect the target sensing signal to obtain a first sensing measurement result includes one of the following:
1) First channel information H′ (the channel information is non-real channel information) obtained by detecting the target sensing signal based on the first sensing signal known to a receiving end and a sending end, optionally information related to H′, for example, an amplitude/a phase, or an I channel/a Q channel, and a related operation result thereof (which may be a compressed and quantized result), is used as the first sensing measurement result.
2) Related information of the received target sensing signal, for example, an amplitude/a phase, or an I channel/a Q channel, and a related operation result thereof (which may be a compressed and quantized result), is used as the first sensing measurement result.

In this embodiment, after obtaining the target sensing measurement result, the second device may further send the target sensing measurement result to the first device.

For example, the target sensing measurement result is a measurement result obtained by measuring a sensing measurement quantity, and the sensing measurement quantity includes measured quantities at one or more grades. The target sensing measurement result is obtained based on a measured quantity at a specific grade.

For example, the sensing measurement quantity includes at least one of a first-grade measured quantity, a second-grade measured quantity, a third-grade measured quantity, and a fourth-grade measured quantity.

The first-grade measured quantity may be a received signal/original channel information, which includes at least one of the following: a complex result, an amplitude or a phase, and an I channel or a Q channel of a received signal or a channel response. For example, the first-grade measured quantity includes a complex result, an amplitude/a phase, and an I channel/a Q channel, and a related operation result thereof of a received signal or a channel response.

The second-grade measured quantity may be a basic measurement quantity, which includes at least one of the following: a delay, Doppler, an angle, and an intensity. For example, the second-grade measured quantity includes a delay, Doppler, an angle, an intensity, and a multidimensional combination representation thereof.

The third-grade measured quantity may be a basic attribute/state, which includes at least one of the following: a range, a velocity, an orientation, a position, and an acceleration.

The fourth-grade measured quantity may be an advanced attribute/state, which includes at least one of the following: whether a target exists, a trajectory, an action, an expression, a vital sign, a quantity, an imaging result, weather, air quality, a shape, a material, and a component.

To describe the processing method for sensing measurement provided in embodiments of this application in detail, a description is provided in combination with a plurality of specific embodiments.

### Embodiment I

In this embodiment, range/delay information is mainly encrypted, including the following steps:

Step 1: A first device determines first information based on a sensing privacy requirement, and sends the first information to a second device. A source of the sensing privacy requirement may be at least one of the following:
1) The sensing privacy requirement comes from an external application. In this case, an Application Function (AF) sends the sensing privacy requirement to a Network Exposure Function (NEF), and then sends the sensing privacy requirement to the AMF. The AMF selects a SensingMF, and sends the sensing privacy requirement to the SensingMF, that is, the first device.
2) The sensing privacy requirement comes from the external application. The AF sends the sensing privacy requirement to the NEF. The NEF selects the SensingMF, and sends the sensing privacy requirement to the SensingMF.
3) The sensing privacy requirement may, in some embodiments, come from a base station and/or a UE. In this case, the base station and/or the UE sends the sensing privacy requirement to the AMF. The AMF selects the SensingMF, and sends the sensing privacy requirement to the SensingMF.
4) The sensing privacy requirement may, in some embodiments, come from a supervision department. In this case, the supervision department sends the sensing privacy requirement to the AMF. The AMF selects the SensingMF, and sends the sensing privacy requirement to the SensingMF. Alternatively, the supervision department directly sends the sensing privacy requirement to the SensingMF. Alternatively, the supervision department sends the sensing privacy requirement to a network management system of an operator, and then the network management system sends the sensing privacy requirement to the SensingMF, or sends the sensing privacy requirement to the SensingMF through the AMF.
5) The AF or the base station or the UE directly sends the sensing privacy requirement to the SensingMF (without a need for forwarding through the AMF).

Step 2: A second device obtains first information, and then determines at least one of the following information:
1) determining of whether to encrypt a sensing signal based on an encryption requirement identifier;
2) based on information of a sensing measurement node which is prohibited from obtaining or allowed to obtain a valid sensing measurement result;
3) time at which some sensing measurement nodes are prohibited from obtaining or allowed to obtain the valid sensing measurement result;
4) an area and a direction in which obtaining of the valid sensing information is prohibited or allowed;
5) determining of a sensing signal (a first sensing signal) that needs to be encrypted;
6) sensing of different areas since different sensing signals may be used to be sent to different third devices or correspond to different transmission directions, or the like; and
7) encryption of the range/delay information in the sensing measurement results as needed, and determining a specific encryption manner/a manner of generating a first encrypted signal.

Step 3: The second device generates a first sensing signal r(m) at a current moment, where m=0, 1, 2, . . . , and M-1 corresponds to a frequency domain sampling point or a serial number of a subcarrier.

For example, the first sensing signal adopts a pseudo-random sequence (Pseudo Noise (PN) sequence, which is the same as that in a current 5G NR standard) modulated based on Quadrature Phase Shift Keying (QPSK), and an equation is generated as follows:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where c(n) is a PN sequence, and is constructed as follows:

$$c ( n ) = ( {x}_{1} ( n + {N}_{c} ) + {x}_{2} ( n + {N}_{c} ) ) mod 2$$

$${x}_{1} ( n + 31 ) = ( {x}_{1} ( x + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

N_{c}=1600, an initialization manner of a first m sequence x₁(n) is x¹(0)=1, x₁(n)=0, n=1,2, . . . ,30, and an initialization manner of a second m sequence x₂(n) is cᵢₙᵢₜ=Σᵢ₌₀³⁰x₂(i)·2ⁱ·cᵢₙᵢₜ represents an initialization factor, which is associated with a specific use of the PN sequence.

An example of a first sensing signal corresponding to different moments is shown in FIG. 3. Assuming that a current moment is t1, the corresponding first sensing signal r(m) occupies m subcarriers in a frequency domain.

Step 4: The second device generates a first encrypted signal r1(m), where m=0,1,2 . . . , M-1 corresponds to a frequency domain sampling point or a serial number of a subcarrier.

For example, the first sensing signal uses a pseudo random sequence modulated based on the QPSK, which is generated in the same manner as the first sensing signal, and may be, for example,

$$r 1 ( m ) = ( \frac{1}{\sqrt{2}} ( 1 - 2 \cdot c\_s ( 2 m ) ) + j \frac{1}{\sqrt{2}} ( 1 - 2 \cdot c\_s ( 2 m + 1 ) ) ) \cdot {e}^{j π / 4}$$

A PN sequence generation initialization factor is associated with a sensing service Identifier (ID) or a sensing encryption ID, and is unrelated to time information. For example, the PN sequence generation initialization factor may be:

$$c {1}_{i n i t} = ( {2}^{10} ( 2 {n}_{sensingID} + 1 ) + {n}_{sensingID} ) mod {2}^{31}$$

A first encrypted signal corresponding to each moment uses the same c1ᵢₙᵢₜ, and a feature of the generated first encrypted signal is that each moment corresponds to the same first encrypted signal, and elements in each encrypted signal are not exactly the same (which are related to characteristics of the PN sequence).

Step 5: The second device generates a target sensing signal based on the first sensing signal and a first encrypted signal corresponding to a current sending moment. Specifically, a manner is r′(m)=r(m)*r1(m), where m=0,1,2 . . . , M-1 corresponds to a frequency domain sampling point or a serial number of a subcarrier.

Specifically, as shown in FIG. 3, first sensing signals corresponding to a moment t1, a moment t2, a moment t3, . . . are multiplied in the frequency domain respectively by first encrypted signals corresponding to the moments.

Step 6: The second device sends the target sensing signal to the third device, and the third device receives the target sensing signal and then performs channel estimation based on the known first sensing signal r(m), to obtain first channel information H′ (the channel information is non-real channel information). In this case, the third device performs delay and Doppler detection based on H′, and a detection result is as follows. In this case, determined Doppler/velocity information can be detected, and determined delay/range information cannot be obtained.

Step 7: The third device obtains a first sensing measurement result based on H′, and sends the first sensing measurement result to the second device.

Step 8: The second device determines H′ based on the first sensing measurement result, and obtains real channel information H based on the first encrypted signal r1(m). In this case, the determined Doppler/velocity information and the determined delay/range information can be detected.

### Embodiment II

In this embodiment, velocity/Doppler information is mainly encrypted, including the following steps:

Step 1: A second device obtains first information, and then determines at least one of the following information:
1) determining of whether to encrypt a sensing signal based on an encryption requirement identifier;
2) based on information of a sensing measurement node which is prohibited from obtaining or allowed to obtain a valid sensing measurement result;
3) time at which some sensing measurement nodes are prohibited from obtaining or allowed to obtain the valid sensing measurement result;
4) an area and a direction in which obtaining of the valid sensing information is prohibited or allowed;
5) determining of a sensing signal (a first sensing signal) that needs to be encrypted;
6) sensing of different areas since different sensing signals may be used to be sent to different third devices or correspond to different transmission directions, or the like; and
7) encryption of the range/delay information in the sensing measurement results as needed, and determining a specific encryption manner/a manner of generating a first encrypted signal.

Step 2: The second device generates a first sensing signal. The generation manner is the same as that in Embodiment I.

Step 3: The second device generates a first encrypted signal r1(m), where m=0,1,2 . . . , M-1 corresponds to a frequency domain sampling point or a serial number of a subcarrier.

For example, the first sensing signal uses a pseudo random sequence modulated based on the QPSK, which is generated in the same manner as the first sensing signal, and may be, for example,

$$r 1 ( m ) = ( \frac{1}{\sqrt{2}} ( 1 - 2 \cdot c\_s ( 0 ) ) + j \frac{1}{\sqrt{2}} ( 1 - 2 \cdot c\_s ( 1 ) ) ) \cdot {e}^{j π / 4}$$

A PN sequence generation initialization factor is associated with a sensing service ID or a sensing encryption ID, and is unrelated to time information. For example, the PN sequence generation initialization factor may be:

$$c {1}_{init} = ( {2}^{10} ( ( {N}_{slot}^{frame , μ} {n}_{f} + {n}_{s , f}^{μ} ) {N}_{symb}^{slot} + l + 1 ) ( 2 {n}_{sensingID} + 1 ) + {n}_{sensingID} ) mod {2}^{31}$$

where Nₛₗₒₜ^{frame,μ} represents a quantity of slots in each frame, N_{symb}^{slot} represents a quantity of symbols in each slot, n_{f} represents a current frame number, n_{s,f}^{μ} represents a current slot number, and l represents a serial number of a current symbol. In this way, a first encrypted signal corresponding to each moment uses different c1ᵢₙᵢₜ, and a feature of the generated first encrypted signal is that the first encrypted signals corresponding to each moment are not exactly the same, and elements in each encrypted signal are the same (that is, different frequency domain sampling points correspond to the same r1(m)).

Step 4: The second device generates a target sensing signal based on the first sensing signal and a first encrypted signal corresponding to a current sending moment. Specifically, a manner is r′(m)=r m)*r1(m), where m=0,1,2 . . . , M-1 corresponds to a frequency domain sampling point or a serial number of a subcarrier.

Step 5: The second device sends the target sensing signal to the third device, and the third device receives the target sensing signal and then performs channel estimation based on the known first sensing signal r(m), to obtain first channel information H′ (the channel information is non-real channel information). In this case, the third device performs delay and Doppler detection based on H′. In this case, determined delay/range information can be detected, and determined Doppler/velocity information cannot be obtained.

Step 6: The third device obtains a first sensing measurement result based on H′, and sends the first sensing measurement result to the second device.

Step 7: The second device determines H′ based on the first sensing measurement result, and obtains real channel information H based on the first encrypted signal r1(m). The delay and Doppler detection is performed based on H. In this case, the determined Doppler/velocity information and the determined delay/range information can be detected.

### Embodiment III

In this embodiment, the range/delay information and the velocity/Doppler information are mainly encrypted, including the following steps:

Step 1: A second device obtains first information, and then determines at least one of the following information:
1) determining of whether to encrypt a sensing signal based on an encryption requirement identifier;

2) based on information of a sensing measurement node which is prohibited from obtaining or allowed to obtain a valid sensing measurement result;
3) time at which some sensing measurement nodes are prohibited from obtaining or allowed to obtain the valid sensing measurement result;
4) an area and a direction in which obtaining of the valid sensing information is prohibited or allowed;
5) determining of a sensing signal (a first sensing signal) that needs to be encrypted;
6) sensing of different areas since different sensing signals may be used to be sent to different third devices or correspond to different transmission directions, or the like; and
7) encryption of the range/delay information in the sensing measurement results as needed, and determining a specific encryption manner/a manner of generating a first encrypted signal.

Step 2: The second device generates a first sensing signal. The generation manner is the same as that in Embodiment I.

Step 3: The second device generates a first encrypted signal r1(m), where m=0,1,2 . . . , M-1 corresponds to a frequency domain sampling point or a serial number of a subcarrier.

For example, the first sensing signal uses a pseudo random sequence modulated based on the QPSK, which is generated in the same manner as the first sensing signal, and may be, for example,

$$r 1 ( m ) = ( \frac{1}{\sqrt{2}} ( 1 - 2 \cdot c\_s ( 2 m ) ) + j \frac{1}{\sqrt{2}} ( 1 - 2 \cdot c\_s ( 2 m + 1 ) ) ) \cdot {e}^{j π / 4}$$

A PN sequence generation initialization factor is associated with a sensing service ID or a sensing encryption ID, and is unrelated to time information. For example, the PN sequence generation initialization factor may be:

$$c {1}_{init} = ( {2}^{10} ( ( {N}_{slot}^{frame , μ} {n}_{f} + {n}_{s , f}^{μ} ) {N}_{symb}^{slot} + l + 1 ) ( 2 {n}_{sensingID} + 1 ) + {n}_{sensingID} ) mod {2}^{31}$$

where Nₛₗₒₜ^{frame,μ} represents a quantity of slots in each frame, N_{symb}^{slot} represents a quantity of slot symbols in each slot, n_{f} represents a current frame number, n_{s,f}^{μ} represents a current slot number, and l represents a serial number of a current symbol. In this way, a first encrypted signal corresponding to each moment uses different c1ᵢₙᵢₜ, and a feature of the generated first encrypted signal is that the first encrypted signals corresponding to each moment are not exactly the same, and elements in each encrypted signal are not exactly the same.

Step 4: The second device generates a target sensing signal based on the first sensing signal and a first encrypted signal corresponding to a current sending moment. Specifically, a manner is r′(m)=r(m)*r1(m), where m=0,1,2 . . ., M-1 corresponds to a frequency domain sampling point or a serial number of a subcarrier.

Step 5: The second device sends the target sensing signal to the third device, and the third device receives the target sensing signal and then performs channel estimation based on the known first sensing signal r m), to obtain first channel information H′ (the channel information is non-real channel information). In this case, the third device performs delay and Doppler detection based on H′. In this case, determined delay/range information and determined Doppler/velocity information cannot be obtained.

Step 6: The third device obtains a first sensing measurement result based on H′, and sends the first sensing measurement result to the second device, as described in solutions of this application.

Step 7: The second device determines H′ based on the first sensing measurement result, and obtains real channel information H based on the first encrypted signal r1(m). The delay and Doppler detection is performed based on H. In this case, the determined Doppler/velocity information and the determined delay/range information can be detected.

### Embodiment IV

In this embodiment, encryption is mainly performed on a receiving end and a sending end simultaneously, including the following steps:

Step 1: A second device obtains first information, and then determines a manner of generating a target sensing signal, for example, generating a second sensing signal unknown to a receiving end as the target sensing signal. It is assumed that the second sensing signal uses a pseudo random sequence modulated based on QPSK as described in Embodiment I. An initialization factor is associated with a first sensing service ID or a first sensing encryption ID indicated by a first device.

$$c {1}_{init} = ( {2}^{10} ( ( {N}_{slot}^{frame , μ} {n}_{f} + {n}_{s , f}^{μ} ) {N}_{symb}^{slot} + l + 1 ) ( 2 {n}_{sensingID 1} + 1 ) + {n}_{sensingID 1} ) mod {2}^{31}$$

Step 2: The second device sends the target sensing signal to a third device.

Step 3: The third device obtains second information, and then generates a third sensing signal unknown to a sending end. It is assumed that the third sensing signal uses the pseudo random sequence modulated based on the QPSK as described in Embodiment I. The initialization factor is associated with a second sensing service ID or a second sensing encryption ID indicated by the first device.

$$c {2}_{init} = ( {2}^{10} ( ( {N}_{slot}^{frame , μ} {n}_{f} + {n}_{s , f}^{μ} ) {N}_{symb}^{slot} + l + 1 ) ( 2 {n}_{sensingID 2} + 1 ) + {n}_{sensingID 2} ) mod {2}^{31}$$

Step 4: The third device receives the target sensing signal, then performs channel estimation based on the third sensing signal, to obtain second channel information H″, then obtains a second sensing measurement result based on H″, and sends the second sensing measurement result to the second device or the first device.

According to the encryption method in this embodiment, neither the second device nor the third device participating in sensing measurement can obtain the target sensing measurement result that reflects the real channel information, and only the first device may obtain the target sensing measurement result.

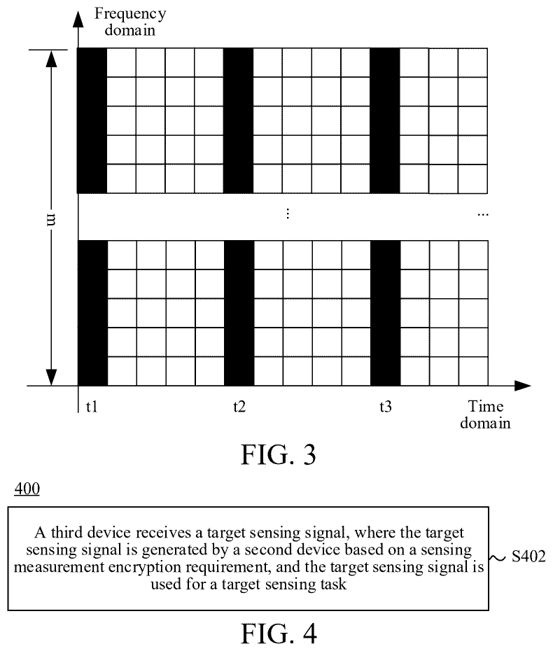

FIG. 4 is a schematic flowchart of implementation of a processing method for sensing measurement according to an embodiment of this application. The method may be applied to a third device. As shown in FIG. 4, a method 400 includes the following steps.

S402: A third device receives a target sensing signal. The target sensing signal is generated by a second device based on a sensing measurement encryption requirement. The target sensing signal is used for a target sensing task.

According to the processing method for sensing measurement provided in this embodiment of this application, the third device receives the target sensing signal. The target sensing signal is generated by the second device based on the sensing measurement encryption requirement. Since the target sensing signal is generated based on the sensing measurement encryption requirement, a specific device can obtain a correct sensing measurement result, which helps improve security of a sensing result.

It should be noted that, in this application, a signal sent by the second device is referred to as the target sensing signal, and a signal received by the third device (the signal passes through a channel) is also referred to as the target sensing signal. A purpose of such a description is to facilitate correspondence and understanding. In fact, specific contents of the foregoing two signals may be different. For example, the signal sent by the second device may be a local reference signal for the third device, which is used to perform relevant calculation on a received reference sequence to obtain a channel estimation result. The signal received by the third device may be a received signal.

For example, in an embodiment, the method further includes: The third device generates a first sensing measurement result based on the target sensing signal. The third device sends the first sensing measurement result. For example, the third device may send the first sensing measurement result to the second device. In some embodiments, the third device may directly send the first sensing measurement result to a first device. In some embodiments, the third device may send the first sensing measurement result to a fourth device.

For example, in an embodiment, the sensing measurement encryption requirement is to perform a first encryption process on a first sensing signal, and that the third device generates a first sensing measurement result based on the target sensing signal includes: detecting, by the third device, the target sensing signal based on the first sensing signal, to obtain first channel information, and using information related to the first channel information as the first sensing measurement result; and/or the sensing measurement encryption requirement is to use a second sensing signal unknown to the third device as the target sensing signal, and that the third device generates a first sensing measurement result based on the target sensing signal includes: using, by the third device, information related to the received target sensing signal as the first sensing measurement result.

For example, in an embodiment, the method further includes: The third device receives second information from a first device. The second information includes a manner of generating a third sensing signal. The third device detects the target sensing signal based on the third sensing signal, to obtain second channel information. The third device obtains a second sensing measurement result based on the second channel information, and sends the second sensing measurement result.

In this embodiment, the second device may perform a first encryption process on the first sensing signal, to obtain the target sensing signal. The second device sends the target sensing signal to the third device. The third device may perform detection or the like on the target sensing signal based on the third sensing signal, to obtain the second sensing measurement result, and sends the second sensing measurement result to the second device. In this way, the second device may obtain a third sensing measurement result based on the second sensing measurement result and the like, and send the third sensing measurement result to the first device. A target sensing measurement result that reflects real channel information is obtained by the first device based on the third sensing measurement result and the like.

Since the third sensing signal is unknown to the second device, the second device cannot obtain a correct sensing measurement result even if the second device obtains the second sensing measurement result, which is equivalent to that a receiving device (that is, the third device) also performs encryption on the sensing signal, which helps improve the security of the sensing result.

In this embodiment, the receiving device of the sensing signal may also perform encryption on the sensing signal based on the sensing measurement encryption requirement, so that only a specific device can obtain the correct sensing measurement result, which helps improve the security of the sensing result.

In this embodiment of this application, the sensing signal is encrypted during the sending and receiving of the signal, which can meet a sensing privacy requirement without affecting sensing performance, to prevent leakage of a valid sensing measurement result.

For example, in an embodiment, before the third device receives the target sensing signal, the method further includes: The third device receives indication information. The indication information is used to indicate that the target sensing signal is a sensing signal generated based on the sensing measurement encryption requirement.

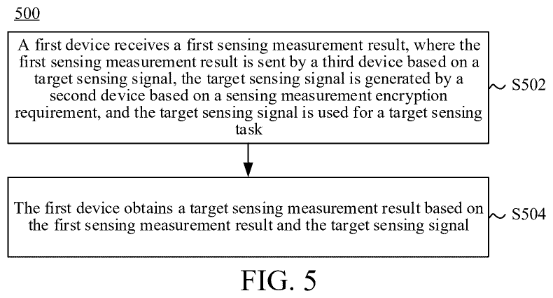

FIG. 5 is a schematic flowchart of implementation of a processing method for sensing measurement according to an embodiment of this application. The method may be applied to a first device. As shown in FIG. 5, a method 500 includes the following steps.

S502: A first device receives a first sensing measurement result. The first sensing measurement result is sent by a third device based on a target sensing signal. The target sensing signal is generated by a second device based on a sensing measurement encryption requirement. The target sensing signal is used for a target sensing task.

S504: The first device obtains a target sensing measurement result based on the first sensing measurement result and the target sensing signal.

According to the processing method for sensing measurement provided in this embodiment of this application, the first device receives the first sensing measurement result. The first sensing measurement result is sent by the third device based on the target sensing signal. The target sensing signal is generated by the second device based on the sensing measurement encryption requirement. The first device obtains the target sensing measurement result based on the first sensing measurement result and the target sensing signal. Since the target sensing signal is generated based on the sensing measurement encryption requirement, a specific device can obtain a correct sensing measurement result, which helps improve security of a sensing result.

For example, in an embodiment, the target sensing measurement result is a measurement result obtained by measuring a sensing measurement quantity, and the sensing measurement quantity includes measured quantities at one or more grades.

For example, in an embodiment, the sensing measurement quantity includes at least one of a first-grade measured quantity, a second-grade measured quantity, a third-grade measured quantity, and a fourth-grade measured quantity. The first-grade measured quantity includes at least one of the following: a complex result, an amplitude or a phase, and an I channel or a Q channel of a received signal or a channel response. The second-grade measured quantity includes at least one of the following: a delay, Doppler, an angle, and an intensity. The third-grade measured quantity includes at least one of the following: a range, a velocity, an orientation, a position, and an acceleration. The fourth-grade measured quantity includes at least one of the following: whether a target exists, a trajectory, an action, an expression, a vital sign, a quantity, an imaging result, weather, air quality, a shape, a material, and a component.

For example, in an embodiment, before the first device receives the first sensing measurement result, the method further includes: The first device sends first information to the second device. The first information is used to indicate the sensing measurement encryption requirement.

For example, in an embodiment, the first information includes at least one of the following: 1) a manner of generating the target sensing signal; 2) an encryption requirement identifier, where the encryption requirement identifier is used to indicate whether to perform encryption on a first sensing signal; 3) a sensing measurement result that needs to be encrypted; 4) information of a sensing measurement node which is prohibited from obtaining or allowed to obtain a valid sensing measurement result; 5) time information of the sensing measurement node which is prohibited from obtaining or allowed to obtain the valid sensing measurement result; and 6) information of a position at which obtaining of the valid sensing information is prohibited or allowed.

For example, in an embodiment, the method further includes: The first device sends second information to the third device. The second information includes a manner of generating a third sensing signal. The third sensing signal is used by the third device to detect the target sensing signal to obtain second channel information, and obtain a second sensing measurement result based on the second channel information. The first device receives the second sensing measurement result. The first device obtains the target sensing measurement result based on the second sensing measurement result, the target sensing signal, and the third sensing signal.

For example, in an embodiment, the method further includes: The first device sends second information to the third device. The second information includes a manner of generating a third sensing signal. The third sensing signal is used by the third device to detect the target sensing signal to obtain second channel information, and obtain a second sensing measurement result based on the second channel information. The first device receives a third sensing measurement result. The third sensing measurement result is obtained and sent by the second device based on the target sensing signal and the second sensing measurement result. The foregoing second device is further configured to receive the second sensing measurement result. The first device obtains the target sensing measurement result based on the third sensing measurement result and the third sensing signal.

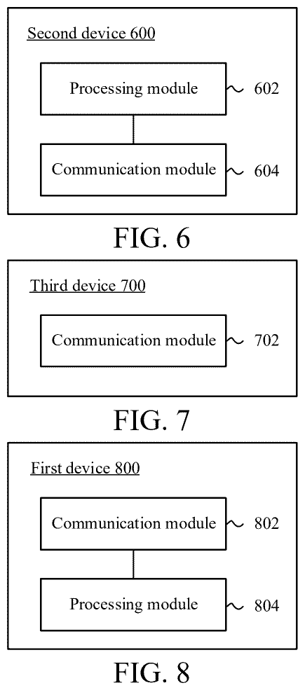

FIG. 6 is a schematic structural diagram of a second device according to an embodiment of this application. As shown in FIG. 6, a second device 600 includes:
a processing module 602, configured to generate a target sensing signal based on a sensing measurement encryption requirement; and
a communication module 604, configured to send the target sensing signal. The target sensing signal is used for a target sensing task.

In embodiments of this application, the second device generates the target sensing signal based on the sensing measurement encryption requirement, and sends the target sensing signal. Since the sent target sensing signal is generated based on the sensing measurement encryption requirement, a specific device can obtain a correct sensing measurement result, which helps improve security of the sensing result.

For example, in an embodiment, the sensing measurement encryption requirement includes at least one of the following: 1) A first encryption process is performed on a first sensing signal, to obtain the target sensing signal. 2) A second sensing signal is used as the target sensing signal, where a third device is configured to receive the target sensing signal, and the second device and the third device do not predefine the second sensing signal.

For example, in an embodiment, the processing module 602 is further configured to generate a first encrypted signal, where the first encrypted signal is used to perform phase rotation on the first sensing signal. The processing module 602 is configured to perform the phase rotation on the first sensing signal by using the first encrypted signal, to obtain the target sensing signal.

For example, in an embodiment, each time-domain position of the first sensing signal corresponds to one first encrypted signal, and each of the first encrypted signals includes m elements. A plurality of time-domain positions correspond to a same first encrypted signal, and the m elements of each first encrypted signal are not exactly the same. Alternatively, the first encrypted signals corresponding to the plurality of time-domain positions are not exactly the same, and the m elements of each first encrypted signal are the same. Alternatively, the first encrypted signals corresponding to the plurality of time-domain positions are not exactly the same, and the m elements of each first encrypted signal are not exactly the same.

For example, in an embodiment, the communication module 604 is further configured to receive a first sensing measurement result. The first sensing measurement result is sent by the third device based on the target sensing signal. The processing module 602 is further configured to obtain a target sensing measurement result based on the first sensing measurement result and the target sensing signal.

For the second device 600 according to this embodiment of this application, reference may be made to the process of the corresponding method 200 in embodiments of this application. In addition, the units/modules of the second device 600 and the foregoing other operations and/or functions are respectively intended to implement the corresponding process of the method 200, and achieve the same or equivalent technical effect. For brevity, details are not described herein.

FIG. 7 is a schematic structural diagram of a third device according to an embodiment of this application. As shown in FIG. 7, a third device 700 includes the following module:
a communication module 702, configured to receive a target sensing signal. The target sensing signal is generated by a second device based on a sensing measurement encryption requirement. The target sensing signal is used for a target sensing task.

In this embodiment of this application, the third device receives the target sensing signal. The target sensing signal is generated by the second device based on the sensing measurement encryption requirement. Since the target sensing signal is generated based on the sensing measurement encryption requirement, a specific device can obtain a correct sensing measurement result, which helps improve security of a sensing result.

For example, in an embodiment, the communication module 702 is further configured to: generate a first sensing measurement result based on the target sensing signal; and send the first sensing measurement result.

For example, in an embodiment, the sensing measurement encryption requirement is to perform a first encryption process on a first sensing signal, and the communication module 702 is configured to detect the target sensing signal based on the first sensing signal, to obtain first channel information, and use information related to the first channel information as the first sensing measurement result; and/or the sensing measurement encryption requirement is to use a second sensing signal unknown to the third device as the target sensing signal, and the communication module 702 is configured to use information related to the received target sensing signal as the first sensing measurement result.

For example, in an embodiment, the communication module 702 is further configured to: receive second information from a first device, where the second information includes a manner of generating a third sensing signal; detect the target sensing signal based on the third sensing signal, to obtain second channel information; and obtain a second sensing measurement result based on the second channel information, and send the second sensing measurement result.

For the third device 700 according to this embodiment of this application, reference may be made to the process of the corresponding method 400 in embodiments of this application. In addition, the units/modules of the third device 700 and the foregoing other operations and/or functions are respectively intended to implement the corresponding process of the method 400, and achieve the same or equivalent technical effect. For brevity, details are not described herein.

FIG. 8 is a schematic structural diagram of a first device according to an embodiment of this application. As shown in FIG. 8, a first device 800 includes the following modules:
a communication module 802, configured to receive a first sensing measurement result, where the first sensing measurement result is sent by a third device based on a target sensing signal, the target sensing signal is generated by a second device based on a sensing measurement encryption requirement, and the target sensing signal is used for a target sensing task; and
a processing module 804, configured to obtain a target sensing measurement result based on the first sensing measurement result and the target sensing signal.

In this embodiment of this application, the first device receives the first sensing measurement result. The first sensing measurement result is sent by the third device based on the target sensing signal. The target sensing signal is generated by the second device based on the sensing measurement encryption requirement. The first device obtains the target sensing measurement result based on the first sensing measurement result and the target sensing signal. Since the target sensing signal is generated based on the sensing measurement encryption requirement, a specific device can obtain a correct sensing measurement result, which helps improve security of a sensing result.

For example, in an embodiment, the communication module 802 is further configured to: send second information to the third device, where the second information includes a manner of generating a third sensing signal, and the third sensing signal is used by the third device to detect the target sensing signal to obtain second channel information, and obtain a second sensing measurement result based on the second channel information; and receive the second sensing measurement result. The processing module 804 is further configured to obtain the target sensing measurement result based on the second sensing measurement result, the target sensing signal, and the third sensing signal.

For example, in an embodiment, the communication module 802 is further configured to: send second information to the third device, where the second information includes a manner of generating a third sensing signal, and the third sensing signal is used by the third device to detect the target sensing signal to obtain second channel information, and obtain a second sensing measurement result based on the second channel information; and receive a third sensing measurement result. The third sensing measurement result is obtained and sent by the second device based on the target sensing signal and the second sensing measurement result. The processing module 804 is further configured to obtain the target sensing measurement result based on the third sensing measurement result and the third sensing signal.

For the first device 800 according to this embodiment of this application, reference may be made to the process of the corresponding method 500 in embodiments of this application. In addition, the units/modules of the first device 800 and the foregoing other operations and/or functions are respectively intended to implement the corresponding process of the method 500, and achieve the same or equivalent technical effect. For brevity, details are not described herein.

The first device, the second device, and the third device in embodiments of this application may be an electronic device, for example, an electronic device having an operating system, or may be a component in the electronic device, for example, an integrated circuit or a chip. The electronic device may be a terminal, or may be another device other than the terminal. In an example, the terminal may include but is not limited to the above listed types of the terminal 11, and the another device may be a server, a Network Attached Storage (NAS), or the like. This is not specifically limited in embodiments of this application.

The first device, the second device, and the third device provided in embodiments of this application can respectively implement the processes implemented in the method embodiments of FIG. 5, FIG. 2, and FIG. 4, and achieve the same technical effect. To avoid repetition, details are not described herein.

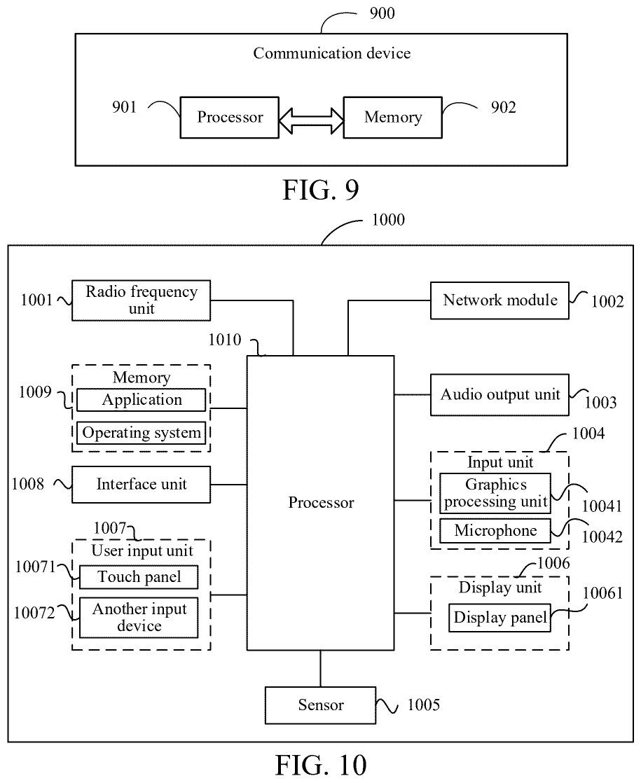

For example, as shown in FIG. 9, an embodiment of this application further provides a communication device 900, including a processor 901 and a memory 902. The memory 902 stores a program or instructions executable in the processor 901. For example, when the communication device 900 is a terminal, the program or the instructions, when executed by the processor 901, implement the steps in the foregoing embodiments of the processing method for sensing measurement, and can achieve the same technical effect. When the communication device 900 is a network side device, the program or the instructions, when executed by the processor 901, implement the steps in the foregoing embodiments of the processing method for sensing measurement, and can achieve the same technical effect. To avoid repetition, details are not described herein.

An embodiment of this application further provides a terminal, including a processor and a communication interface. The processor and the communication interface are configured to implement the processes of the method embodiments of FIG. 2, FIG. 4, and FIG. 5. The terminal embodiment corresponds to the foregoing method embodiment of the terminal side. The implementation processes and implementations of the foregoing method embodiment are all applicable to the terminal embodiment, and can achieve the same technical effect. Specifically, FIG. 10 is a schematic diagram of a hardware structure of a terminal for implementing an embodiment of this application.

A terminal 1000 includes but is not limited to at least some of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to components. The power supply may be logically connected to the processor 1010 through a power management system, thereby implementing functions such as management of charging, discharging, and power consumption through the power management system. The terminal structure shown in FIG. 10 constitutes no limitation on the terminal, and the terminal may include more or fewer components than those shown in the figure, or some merged components, or different component arrangements. Details are not described herein.

It should be noted that, in this embodiment of this application, the input unit 1004 may include a Graphics Processing Unit (GPU) 10041 and a microphone 10042. The graphics processing unit 10041 processes image data of a static picture or a video obtained by an image capturing apparatus (such as a camera) in a video capturing mode or an image capturing mode. The display unit 1006 may include a display panel 10061. The display panel 10061 may be configured in a form such as a liquid crystal display or an organic light-emitting diode. The user input unit 1007 includes at least one of a touch panel 10071 and another input device 10072. The touch panel 10071 is also referred to as a touch screen. The touch panel 10071 may include a touch detection apparatus and a touch controller. The another input device 10072 may include but is not limited to a physical keyboard, a function button (such as a volume control button or a power button), a trackball, a mouse, and a joystick. Details are not described herein.

In this embodiment of this application, the radio frequency unit 1001 receives downlink data from a network side device, and then may transmit the data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or instructions and various data. The memory 1009 may include mainly a first storage area for storing a program or instructions and a second storage area for storing data. The first storage area may store an operating system, an application or an instruction required for at least one function (such as a sound playback function and an image playback function), and the like. In addition, the memory 1009 may include a volatile memory or a non-volatile memory, or the memory 1009 may include both the volatile memory and the non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these and any other suitable types of memories.

The processor 1010 may include one or more processing units. For example, an application processor and a modem processor are integrated into the processor 1010. The application processor is mainly configured to process operations related to an operating system, a user interface, an application, and the like. The modem processor such as a baseband processor is mainly configured to process a wireless communication signal. It may be understood that, in some embodiments, the modem processor may not be integrated into the processor 1010.

The radio frequency unit 1001 and the processor 1010 may be configured to implement the processes for implementation of the method embodiments of FIG. 2, FIG. 4, and FIG. 5.

In embodiments of this application, since the target sensing signal is generated based on the sensing measurement encryption requirement, a specific device can obtain a correct sensing measurement result, which helps improve security of the sensing result.

The terminal 1000 provided in this embodiment of this application may further implement the processes in the foregoing embodiments of the processing method for sensing measurement, and can achieve the same technical effect. To avoid repetition, details are not described herein.

An embodiment of this application further provides a network side device, including a processor and a communication interface. The processor and the communication interface are configured to implement the processes for implementation of the method embodiments of FIG. 2, FIG. 4, and FIG. 5. The network side device embodiment corresponds to the foregoing method embodiment of the network side device. The implementation processes and implementations of the foregoing method embodiment are all applicable to the embodiment of the network side device, and can achieve the same technical effect.

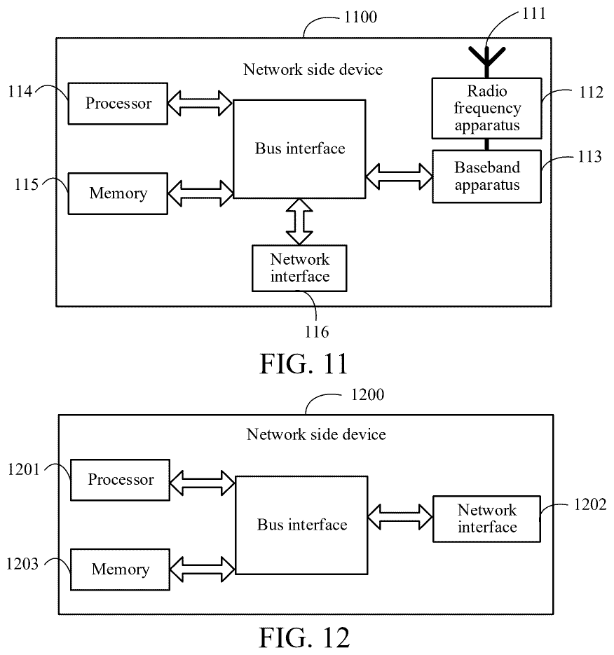

Specifically, an embodiment of this application further provides a network side device. As shown in FIG. 11, a network side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends the processed to-be-sent information to the radio frequency apparatus 112. The radio frequency apparatus 112 processes the received information, and then sends the processed information through the antenna 111.

The method performed by the network side device in the foregoing embodiments may be implemented by the baseband apparatus 113. The baseband apparatus 113 includes a baseband processor.

The baseband apparatus 113 may include, for example, at least one baseband board. A plurality of chips are arranged on the baseband board, as shown in FIG. 11. One of the chips is, for example, a baseband processor, and is connected to the memory 115 through a bus interface to call a program in the memory 115, to perform the operations of the network device shown in the foregoing method embodiment.

The network side device may further include a network interface 116. The interface is, for example, a Common Public Radio Interface (CPRI).

Specifically, the network side device 1100 in this embodiment of this application further includes instructions or a program stored in the memory 115 and executable in the processor 114. The processor 114 calls the instructions or the program in the memory 115 to perform the method performed by each module shown in FIG. 6, FIG. 7, or FIG. 8, and to achieve the same technical effect. To avoid repetition, details are not described herein.

Specifically, an embodiment of this application further provides a network side device. As shown in FIG. 12, a network side device 1200 includes a processor 1201, a network interface 1202, and a memory 1203. The network interface 1202 is, for example, a CPRI.

Specifically, the network side device 1200 in this embodiment of this application further includes instructions or a program stored in the memory 1203 and executable in the processor 1201. The processor 1201 calls the instructions or the program in the memory 1203 to perform the method performed by each module shown in FIG. 6, FIG. 7, or FIG. 8, and to achieve the same technical effect. To avoid repetition, details are not described herein.

An embodiment of this application further provides a readable storage medium. The readable storage medium stores a program or instructions. The program or the instructions, when executed by a processor, implement the processes in the foregoing embodiments of the processing method for sensing measurement, and can achieve the same technical effect. To avoid repetition, details are not described herein.

The processor is a processor in the terminal described in the foregoing embodiments. The readable storage medium includes a computer-readable storage medium, such as a computer read-only memory ROM, a random access memory RAM, a magnetic disk, or an optical disk.

An embodiment of this application further provides a chip. The chip includes a processor and a communication interface. The communication interface is coupled to the processor. The processor is configured to execute a program or an instruction, to implement the processes in the foregoing embodiments of the processing method for sensing measurement, and can achieve the same technical effects. To avoid repetition, details are not described herein.

It should be understood that the chip mentioned in this embodiment of this application may also be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes in the foregoing embodiments of the processing method for sensing measurement, and can achieve the same technical effects. To avoid repetition, details are not described herein.

An embodiment of this application further provides an encryption processing system for sensing measurement, including a terminal and a network side device. The terminal may be configured to perform the steps of the processing method for sensing measurement as described above, and the network side device may be configured to perform the steps of the processing method for sensing measurement as described above.

It should be noted that, the term “comprise”, “include”, or any other variant herein is intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in implementations of this application is not limited to execution of functions in the order shown or discussed, and may further include execution of functions in a substantially simultaneous manner or in a reverse order based on the functions involved. For example, the described method may be performed in a different order from the described order, and various steps may also be added, omitted, or combined. In addition, features described with reference to some examples may be combined in another example.

According to the descriptions of the foregoing implementations, a person skilled in the art may clearly learn that the method in the foregoing embodiments may be implemented by software with a necessary universal hardware platform, or may be implemented by hardware. However, in many cases, the software with a necessary universal hardware platform is an example implementation. Based on such an understanding, the technical solutions of this application, in essence, or a part contributing to the prior art may be embodied in a form of a computer software product. The computer software product is stored in a storage medium (such as a ROM/RAM, a magnetic disk, or an optical disk), including a plurality of instructions for causing a terminal (which may be a mobile phone, a computer, a server, an air conditioner, a network device, or the like) to perform the method in embodiments of this application.

Although embodiments of this application are described above with reference to the accompanying drawings, this application is not limited to the specific implementations described above. The foregoing specific implementations are illustrative but not restrictive. With the enlightenment of this application, a person of ordinary skill in the art may make many forms without departing from the concept of this application and the protection scope of the claims. These forms fall within the protection of this application.

What is claimed is:

1. A processing method for sensing measurement, comprising:
receiving, by a first device, a first sensing measurement result, wherein the first sensing measurement result is sent by a third device based on a target sensing signal, the target sensing signal is generated by a second device based on a sensing measurement encryption requirement, and the target sensing signal is used for a target sensing task; and
obtaining, by the first device, a target sensing measurement result based on the first sensing measurement result and the target sensing signal.

2. The processing method according to claim 1, wherein the target sensing measurement result is a measurement result obtained by measuring a sensing measurement quantity, and the sensing measurement quantity comprises measured quantities at one or more grades.

3. The processing method according to claim 2, wherein the sensing measurement quantity comprises at least one of a first-grade measured quantity, a second-grade measured quantity, a third-grade measured quantity, or a fourth-grade measured quantity, wherein
the first-grade measured quantity comprises at least one of the following: a complex result, an amplitude or a phase, or an I channel or a Q channel of a received signal or a channel response;
the second-grade measured quantity comprises at least one of the following: a delay, Doppler, an angle, or an intensity;
the third-grade measured quantity comprises at least one of the following: a range, a velocity, an orientation, a position, or an acceleration; or
the fourth-grade measured quantity comprises at least one of the following: whether a target exists, a trajectory, an action, an expression, a vital sign, a quantity, an imaging result, weather, air quality, a shape, a material, or a component.

4. The processing method according to claim 1, wherein before the receiving, by the first device, the first sensing measurement result, the method further comprises:
sending, by the first device, first information to the second device, wherein the first information is used to indicate the sensing measurement encryption requirement.

5. The processing method according to claim 4, wherein the first information comprises at least one of the following:
a manner of generating the target sensing signal;
an encryption requirement identifier, wherein the encryption requirement identifier is used to indicate whether to perform encryption on a first sensing signal;
a sensing measurement result that needs to be encrypted;
information of a sensing measurement node which is prohibited from obtaining or allowed to obtain a valid sensing measurement result;
time information of the sensing measurement node which is prohibited from obtaining or allowed to obtain the valid sensing measurement result; or information of a position at which obtaining of the valid sensing information is prohibited or allowed.

6. The processing method according to claim 1, further comprising:
sending, by the first device, second information to the third device, wherein the second information comprises a manner of generating a third sensing signal, and the third sensing signal is used by the third device to detect the target sensing signal to obtain second channel information, and obtain a second sensing measurement result based on the second channel information;
receiving, by the first device, the second sensing measurement result; and
obtaining, by the first device, the target sensing measurement result based on the second sensing measurement result, the target sensing signal, and the third sensing signal.

7. The processing method according to claim 1, further comprising:
sending, by the first device, second information to the third device, wherein the second information comprises a manner of generating a third sensing signal, and the third sensing signal is used by the third device to detect the target sensing signal to obtain second channel information, and obtain a second sensing measurement result based on the second channel information;
receiving, by the first device, a third sensing measurement result, wherein the third sensing measurement result is obtained and sent by the second device based on the target sensing signal and the second sensing measurement result; and
obtaining, by the first device, the target sensing measurement result based on the third sensing measurement result and the third sensing signal.

8. A processing method for sensing measurement, comprising:
generating, by a second device, a target sensing signal based on a sensing measurement encryption requirement; and
sending, by the second device, the target sensing signal, wherein the target sensing signal is used for a target sensing task.

9. The processing method according to claim 8, wherein the sensing measurement encryption requirement comprises at least one of the following:
performing a first encryption process on a first sensing signal, to obtain the target sensing signal; or
using a second sensing signal as the target sensing signal, wherein a third device is configured to receive the target sensing signal.

10. The processing method according to claim 9, further comprising:
generating, by the second device, a first encrypted signal, wherein the first encrypted signal is used to perform phase rotation on the first sensing signal,
wherein the performing the first encryption process on the first sensing signal, to obtain the target sensing signal comprises: performing phase rotation on the first sensing signal by using the first encrypted signal, to obtain the target sensing signal.

11. The processing method according to claim 10, wherein each time-domain position of the first sensing signal corresponds to one first encrypted signal, and each of the first encrypted signals comprises m elements, wherein
a plurality of time-domain positions correspond to a same first encrypted signal, and the m elements of each first encrypted signal are not exactly the same; or
the first encrypted signals corresponding to the plurality of time-domain positions are not exactly the same, and the m elements of each first encrypted signal are the same; or
the first encrypted signals corresponding to the plurality of time-domain positions are not exactly the same, and the m elements of each first encrypted signal are not exactly the same.

12. The processing method according to claim 8, wherein before the sending, by the second device, the target sensing signal, the method further comprises:
sending, by the second device, indication information to a third device,
wherein the indication information is used to indicate that the target sensing signal is a sensing signal generated based on the sensing measurement encryption requirement, and the third device is configured to receive the target sensing signal.

13. The processing method according to claim 8, wherein before the generating, by the second device, the target sensing signal based on the sensing measurement encryption requirement, the method further comprises:
receiving, by the second device, first information from a first device, wherein the first information is used to indicate the sensing measurement encryption requirement.

14. The processing method according to claim 13, wherein the first information comprises at least one of the following:
a manner of generating the target sensing signal;
an encryption requirement identifier, wherein the encryption requirement identifier is used to indicate whether to perform encryption on a first sensing signal;
a sensing measurement result that needs to be encrypted;
information of a sensing measurement node which is prohibited from obtaining or allowed to obtain a valid sensing measurement result;
time information of the sensing measurement node which is prohibited from obtaining or allowed to obtain the valid sensing measurement result; or
information of a position at which obtaining of the valid sensing information is prohibited or allowed.

15. The processing method according to claim 8, wherein after the sending, by the second device, the target sensing signal, the method further comprises:
receiving, by the second device, a first sensing measurement result, wherein the first sensing measurement result is sent by a third device based on the target sensing signal; and
obtaining, by the second device, a target sensing measurement result based on the first sensing measurement result and the target sensing signal.

16. A processing method for sensing measurement, comprising:
receiving, by a third device, a target sensing signal, wherein the target sensing signal is generated by a second device based on a sensing measurement encryption requirement, and the target sensing signal is used for a target sensing task.

17. The processing method according to claim 16, further comprising:
generating, by the third device, a first sensing measurement result based on the target sensing signal; and
sending, by the third device, the first sensing measurement result.

18. The processing method according to claim 17, wherein
the sensing measurement encryption requirement is to perform a first encryption process on a first sensing signal, and the generating, by the third device, the first sensing measurement result based on the target sensing signal comprises: detecting, by the third device, the target sensing signal based on the first sensing signal to obtain first channel information, and using information related to the first channel information as the first sensing measurement result; or
the sensing measurement encryption requirement is to use a second sensing signal unknown to the third device as the target sensing signal, and the generating, by the third device, the first sensing measurement result based on the target sensing signal comprises: using, by the third device, information related to the received target sensing signal as the first sensing measurement result.

19. The processing method according to claim 16, further comprising:
receiving, by the third device, second information from a first device, wherein the second information comprises a manner of generating a third sensing signal;
detecting, by the third device, the target sensing signal based on the third sensing signal to obtain second channel information; and
obtaining, by the third device, a second sensing measurement result based on the second channel information, and sending the second sensing measurement result.

20. The processing method according to claim 16, wherein before the receiving, by the third device, the target sensing signal, the method further comprises:
receiving, by the third device, indication information,
wherein the indication information is used to indicate that the target sensing signal is a sensing signal generated based on the sensing measurement encryption requirement.
